(19) United States
(12) Patent Application Publication
(10) Pub. No.: US 2016/0196913 A1
(43) Pub. Date: Jul. 7, 2016

(54) COIL COMPONENT AND METHOD OF MANUFACTURING THE SAME

(71) Applicant: Samsung Electro-Mechanics Co., Ltd., Suwon-si (KR)

(72) Inventors: Hong-Won KIM, Suwon-si (KR); Jeong-Min CHO, Seongnam-si (KR); Jin-Gu KIM, Suwon-si (KR)

(73) Assignee: Samsung Electro-Mechanics Co., Ltd., Suwon-si (KR)

(21) Appl. No.: 14/967,975

(22) Filed: Dec. 14, 2015

(30) Foreign Application Priority Data
Jan. 6, 2015 (KR) 10-2015-0001308

(51) Int. Cl. H01F 17/00; H01F 41/00; H01F 17/04

(52) U.S. Cl. CPC H01F 17/0013; H01F 17/04; H01F 41/00

(57) ABSTRACT

Disclosed is a coil component and method of manufacturing the coil component. The coil component includes a core magnetic layer, coil conductors formed on two opposing surfaces of the core magnetic layer, and outer magnetic layers laminated on the core magnetic layer and covering the coil conductors.

CROSS-REFERENCE TO RELATED APPLICATION(S)

This application claims the benefit under 35 USC §119(a) of Korean Patent Application No. 10-2015-0001308, filed on Jan. 6, 2015 with the Korean Intellectual Property Office, the entire disclosure of which is incorporated herein by reference for all purposes.

### BACKGROUND

1. Field

The following description relates to a coil component and a method of manufacturing the same having an excellent efficiency of magnetic influx.

2. Description of Related Art

Electronic devices such as mobile phones, home appliances, personal computers, personal digital assistants (PDA), liquid crystal displays (LCD) and GPS navigation devices have become more digitalized and faster. As these electronic devices are sensitive to stimulation from outside, any abnormal voltage and high-frequency noise brought into the internal circuit of the electronic device often destroy the circuit or distort signals.

The abnormal voltage and noise may be caused by a switching voltage generated within the circuit, a power noise included in power voltage, an unnecessary electromagnetic signal, or an electromagnetic noise. Various means are used to prevent the abnormal voltage and high-frequency noise from being flowed into the circuit are coil components.

Unlike general single-end transmission systems, high-speed interfaces, such as, for example, USB 2.0, USB 3.0, and high-definition multimedia interface (HDMI), adopt a differential signal system transmitting differential signals (differential mode signals) using a pair of signal lines, and common mode filters (CMF) are used as the coil component for removing common mode noises in the differential signal transmission system.

In a conventional CMF, a coil layer is formed over a ferrite substrate in which magnetic powder is sintered, and a ferrite resin composite for protecting the coil layer and preventing a leakage of magnetic flux is laminated on the coil layer.

The ferrite resin composite is made by mixing magnetic powder with resin, has a significantly smaller magnetic permeability than the ferrite substrate underneath because the magnetic powder is dispersed in the resin, thereby lowering the performance efficiency of the CMF device.

Since the conventional CMF has the structural limitation of lowered efficiency of magnetic flux passing through the central coil layer by the ferrite resin composite, effort is being made to increase the magnetic permeability of the ferrite resin composite in order to improve the performance of the CMF.

Since an insulation layer having a coil installed therein is formed over a highly brittle, ceramic type of ferrite substrate, the problem of delamination or crack occurs between the insulation layer and the ferrite substrate.

To improve the magnetic permeability, the number of turns of the coil is increased by implementing a finer pitch. But this measure requires semiconductor processes and materials, inevitably resulting in increased manufacturing costs.

The related art of the present invention is disclosed in Published Japan Patent Application 2014-107435. All documents cited in the present disclosure, including published documents, patent applications, and patents, may be incorporated herein in their entirety by reference in the same manner as when each cited document is separately and specifically incorporated or incorporated in its entirety.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided a coil component having multiple layers of magnetic layers with a high magnetic permeability.

In another general aspect, there is provided a coil component including a core magnetic layer, coil conductors formed on two opposing surfaces of the core magnetic layer, and outer magnetic layers laminated on the core magnetic layer and covering the coil conductors.

The core magnetic layer and the outer magnetic layers may be made of at least one of Ni-based ferrite, Ni—Zn ferrite, or Ni—Zn—Cu ferrite.

The coil component may include insulation layers disposed between the core magnetic layer and the coil conductors.

The coil component may include polymer resin layers interposed between the core magnetic layer and the outer magnetic layers, and the coil conductors being buried in the polymer resin layers.

The polymer resin layers may include magnetic powder.

The coil conductors may include a first coil conductor and a second coil conductor that are electromagnetically coupled with each other.

The coil may include external terminals disposed on the outer magnetic layers and electrically connected with the coil conductors.

The coil conductors may include metal wiring that winds on a plane in a spiral form, and the metal comprises any one or any combination of silver (Ag), palladium (Pd), aluminum (Al), nickel (Ni), titanium (Ti), gold (Au), copper (Cu), and platinum (Pt).

The coil component may be electrically connected with external terminals through vias.

The coil component of claim 4, wherein the polymer resin layers are configured to provide electrical insulation between turns in the coil conductors.

The polymer resin layers may be configured to be heat-resistant, moisture-resistant, and an insulator.

In another general aspect, there is provided a method of manufacturing a coil component, including preparing a core magnetic layer, forming coil conductors on two opposing surfaces of the core magnetic layer, and laminating outer magnetic layers on the core magnetic layer to cover the coil conductors.

The laminating of the outer magnetic layers may include disposing polymer resin layers between the outer magnetic layers and the core magnetic layer, and compressing the outer magnetic layers towards the core magnetic layer.

The method may include coating insulation layers on the opposing surfaces of the core magnetic layer prior to the forming of the coil conductors.

The method may include forming external terminals on the outer magnetic layers.

The outer magnetic layers may be compressed towards the core magnetic layer under a predetermined condition.

The coating of the insulation layers may include applying a spin coating process to the core magnetic layers to form the insulation layers with thickness sufficient to cover a surface roughness of the core magnetic layer.

Other features and aspects will be apparent from the following detailed description, the drawings, and the claims.

### BRIEF DESCRIPTION OF DRAWINGS

FIG. 1 is a diagram illustrating an example of a coil component.

FIG. 2 is a diagram illustrating an example of a sectional view of the coil component shown in FIG. 1 along the I-I′ line.

FIG. 3 is a diagram illustrating an example of a method of manufacturing a coil component.

FIG. 4, FIG. 5, FIG. 6, FIG. 7, FIG. 8, and FIG. 9 are diagrams illustrating examples of steps of the method of manufacturing a coil component shown in FIG. 3.

Throughout the drawings and the detailed description, unless otherwise described or provided, the same drawing reference numerals refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations is described as an example; the sequence of operations is not limited to that set forth herein and may be changed as is known in the art, with the exception of steps and/or operations that necessarily occur in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure is thorough, complete, and conveys the full scope of the disclosure to one of ordinary skill in the art.

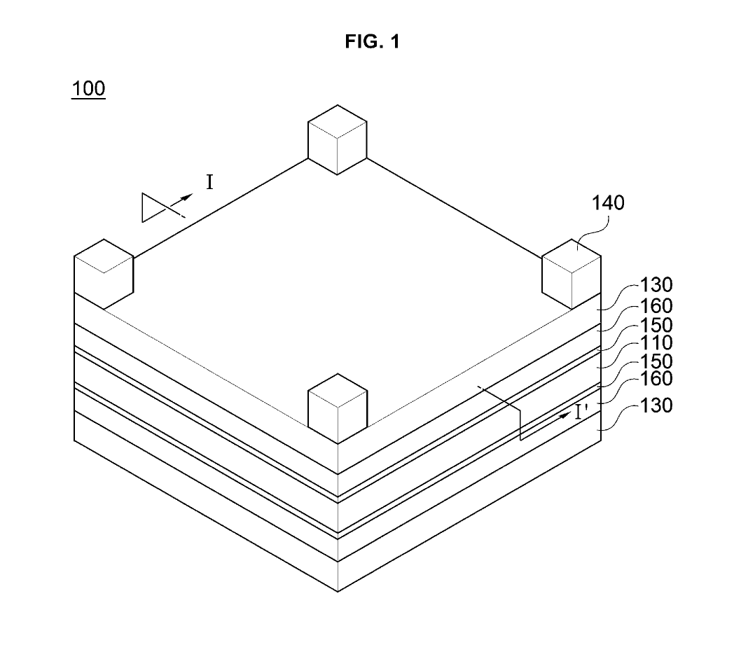

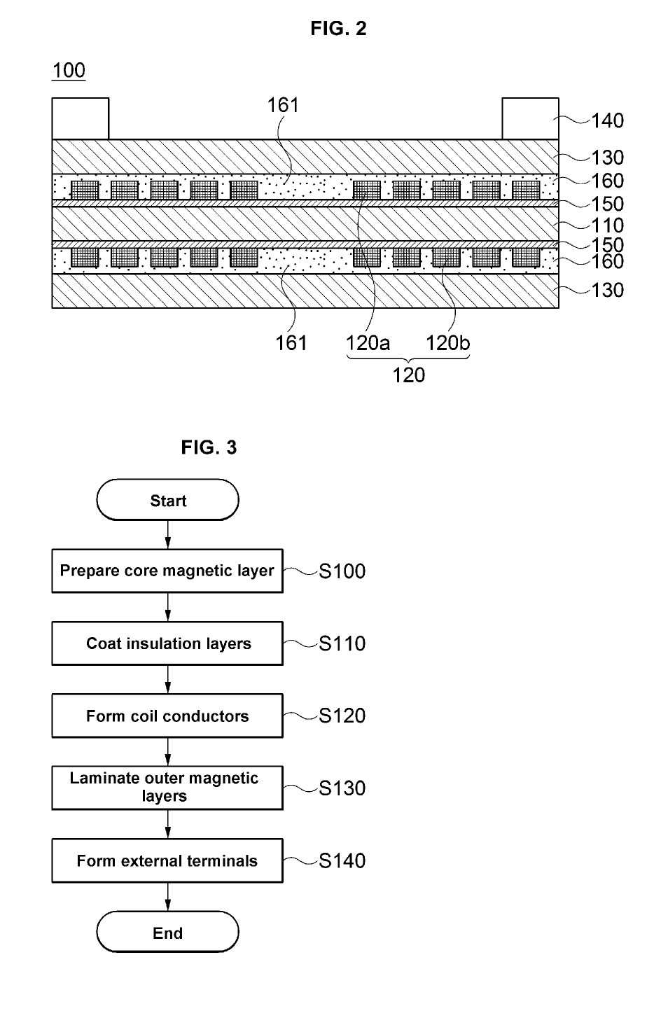

FIG. 1 is a diagram illustrating a view showing a coil component, and FIG. 2 is a diagram illustrating a sectional view of the coil component shown in FIG. 1 along the I-I′ line.

Referring to FIG. 1 and FIG. 2, a coil component 100 in includes a core magnetic layer 110, a coil conductor 120, and an outer magnetic layer 130.

The core magnetic layer 110 is a flat plate type of magnetic member having an upper surface and a lower surface opposite to the upper surface. The core magnetic layer 110 is placed at a middle layer of the coil component 100 to function as a core material. The coil conductor 120 and the outer magnetic layer 130 are laminated successively on the upper surface and the lower surface of the core magnetic layer 110. The core magnetic layer 110 functions as a support for the coil conductor 120 and the outer magnetic layer 130.

The core magnetic layer 110 becomes a moving path of magnetic flux generated when a current is applied. Accordingly, the core magnetic layer 110 may be made of any magnetic material as long as a predetermined inductance may be obtained. For instance, the material constituting the core magnetic layer 110 may be a material such as, for example, a Ni-based ferrite material having Fe₂O₃ and NiO as main components, a Ni—Zn ferrite material having Fe₂O₃, NiO and ZnO as main components, or a Ni—Zn—Cu ferrite material having Fe₂O₃, NiO, ZnO and CuO as main components.

The coil conductor 120, which is a coil pattern of metal wiring that winds on a plane in a spiral form, may be made of at least one of highly electrically conductive metal such as, for example, silver (Ag), palladium (Pd), aluminum (Al), nickel (Ni), titanium (Ti), gold (Au), copper (Cu), and platinum (Pt).

The coil conductor 120 may be provided in multiple layers, in which case the coil conductor 120 on each layer may be separated with a predetermined distance and disposed to face opposite to each other to form a coil by making an interlayer connection through a via or other connecting means.

As shown in FIG. 2, the coil conductor 120 may be constituted with a first coil conductor 120a and a second coil conductor 120b that are electromagnetically coupled with each other and are each forming an individual coil. For instance, as shown in FIG. 2, the coil conductor 120 formed on the upper surface of the core magnetic layer 110 may be the first coil conductor 120a, and the coil conductor 120 formed on the lower surface of the core magnetic layer 110 may be the second coil conductor 120b. In another example, the first coil conductor 120a and the second coil conductor 120b are alternately disposed on a same plane to have the first coil conductor 120a and the second coil conductor 120b installed together on a same layer.

When the first coil conductor 120a and the second coil conductor 120b are electromagnetically coupled with each other, the coil component 100 operates in a common mode filter (CMF) in which the magnetic flux is reinforced and a common mode impedance is increased, if a current is applied to the first coil conductor 120a and the second coil conductor 120b in a same direction. If the current is applied to the first coil conductor 120a and the second coil conductor 120b in opposite directions, the magnetic flux is canceled out and a differential mode impedance is decreased.

The coil conductor 120 is electrically connected with external terminals 140 disposed on the outer magnetic layer 130 through vias or other connecting means. The external terminals 140 are connected with an external circuit through a medium, such as, for example, a conductive adhesive. Through this electrical connection structure, a current provided from an outside is applied to the coil conductor 120 through the external terminals 140.

Since the coil conductor 120 is constituted with the first coil conductor 120a and the second coil conductor 120b forming their respective individual coils, there may be four external terminals 140. A pair of external terminals 140 is connected to either end of the first conductive coil 120a and functioning as input and output terminals of the first conductive coil 120a. Another a pair of external terminals 140 is connected to either end of the second conductive coil 120b and functions as input and output terminals of the second conductive coil 120b. The external terminals 140 are disposed near four corners of the outer magnetic layer 130, in a clockwise or counterclockwise direction from an upper left corner of the outer magnetic layer 130.

An insulation layer 150 may be disposed between the core magnetic layer 110 and the coil conductor 120.

In another example, the coil conductor 120 may be disposed directly on the surface of the core magnetic layer 110 without any insulation layer. However, insulation may be provided between the core magnetic layer 110 and the coil conductor 120 by disposing the insulation layer 150 for a more stable operation.

Since the core magnetic layer 110 is formed by sintering magnetic powder, grains of the magnetic powder may be exposed to the surface of the core magnetic layer 110 and form bumps on the surface of the core magnetic layer 110, deteriorating adhesiveness with the coil conductor 120. Therefore, by implementing the insulation layer 150, the surface roughness of the core magnetic layer 110 may be alleviated, and flatness may be provided on a surface where the coil conductor 120 is formed, thereby improving the adhesiveness with the coil conductor 120. Owing to the adhesiveness of the insulation layer 150, an adhesive force between the coil conductor 120 and the core magnetic layer is enhanced.

The insulation layer 150 may be made of a thermosetting resin, such as, for example, epoxy resin, phenol resin, urethane resin, silicon resin, and polyimide resin. In another example, insulation layer 150 may be made of a thermoplastic resin, such as, for example, polycarbonate resin, acrylic resin, polyacetal resin, and polypropylene resin. The material for the insulation layer 150 shall not be limited to what is described herein, and the insulation layer 150 may be made of any material as long as it has good insulating and adhesive properties.

The outer magnetic layer 130 is laminated on the core magnetic layer 110 having the core conductor 120 formed thereon. Thus, the coil conductor 120 is covered by the outer magnetic layer 130. When the coil conductor 120 is formed on both surfaces of the core magnetic layer 110, outer magnetic layers 130 are disposed above and below the core magnetic layer 110. The outer magnetic layers 130 protect the coil conductor 120 from an outside.

Like the core magnetic layer 110, the outer magnetic layers 130 are made of a highly magnetically permeable material, such as, for example, Ni-based ferrite, Ni—Zn ferrite, and Ni—Zn—Cu ferrite.

The outer magnetic layers 130 have a function of moving paths of magnetic flux, in addition to the role as protective layers. The outer magnetic layers 130 are disposed to face the core magnetic layer 110 with the core magnetic layer 110 disposed between the two outer magnetic layers 130. As a result, the magnetic flux generated when a current is applied passes through the outer magnetic layers 130 at an upper portion and a lower portion of the coil component 100 and through the core magnetic layer 110 at a middle portion of the core component, thereby forming a closed magnetic circuit.

As the core magnetic layer 110 and the outer magnetic layers 130, which are made of sintered ferrite and are highly magnetically permeable, are disposed in the moving paths of the magnetic flux, the magnetic flux may flow readily.

A polymer resin layer 160 is filled in between patterns of the coil conductor 120. The polymer resin layer 160 is configured to provide electrical insulation between turns in the coil conductor 120 and to protect the coil conductor 120 from the outside by enveloping the coil conductor 120. Accordingly, the polymer resin layer 160 may be made of a material having good heat-resistance, moisture-resistance, and insulating property. The polymer resin layer 160 may be a material, such as, for example, epoxy resin, phenol resin, urethane resin, silicon resin, and polyimide resin.

The thickness of the polymer resin layer 160 may be greater than the coil conductors 120. Accordingly, the coil conductor 120 may be disposed in the polymer resin layer 160, and the outer magnetic layer 130 may be electrically insulated from the coil conductor 120 by the polymer resin layer 160. Moreover, the outer magnetic layer 130 and the core magnetic layer 110 may be sturdily joined with each other by the strong adhesiveness of the polymer resin layer 160.

In another example, the polymer resin layer 160 may contain magnetic powder 161.

The magnetic powder 161 may be made of at least one of highly magnetically permeable materials, such as, for example, Ni-based ferrite, Ni—Zn ferrite and Ni—Zn—Cu ferrite. Accordingly, the polymer resin layer 160 may prevent the magnetic flux from being leaked out.

The magnetic permeability increases with an increase in the content of the magnetic powder 161, but the amount of resin is reduced by the increase in the content of the magnetic powder 161. The decrease in the amount of resin may deteriorate the insulating and adhesive properties of the polymer resin layer 160. Therefore, it is preferable to properly adjust the mixing ratio of the magnetic powder 161 when the polymer resin layer 160 is prepared.

As described above, by introducing the highly magnetically permeable core magnetic layer 110 and outer magnetic layers 130 at the middle layer and outermost layers, respectively, as well as the polymer resin layer 160 having the magnetic powder 161 contained therein, the examples described above may increase the magnetic flux. Thus, the cost for manufacturing a fine pattern may be saved because the number of turns in the coil pattern does not have to be increased excessively.

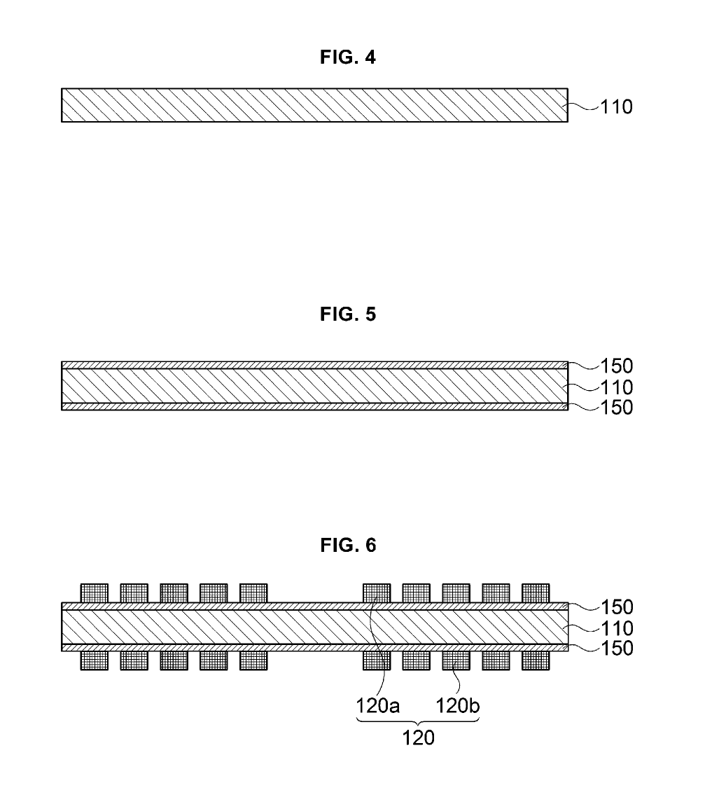

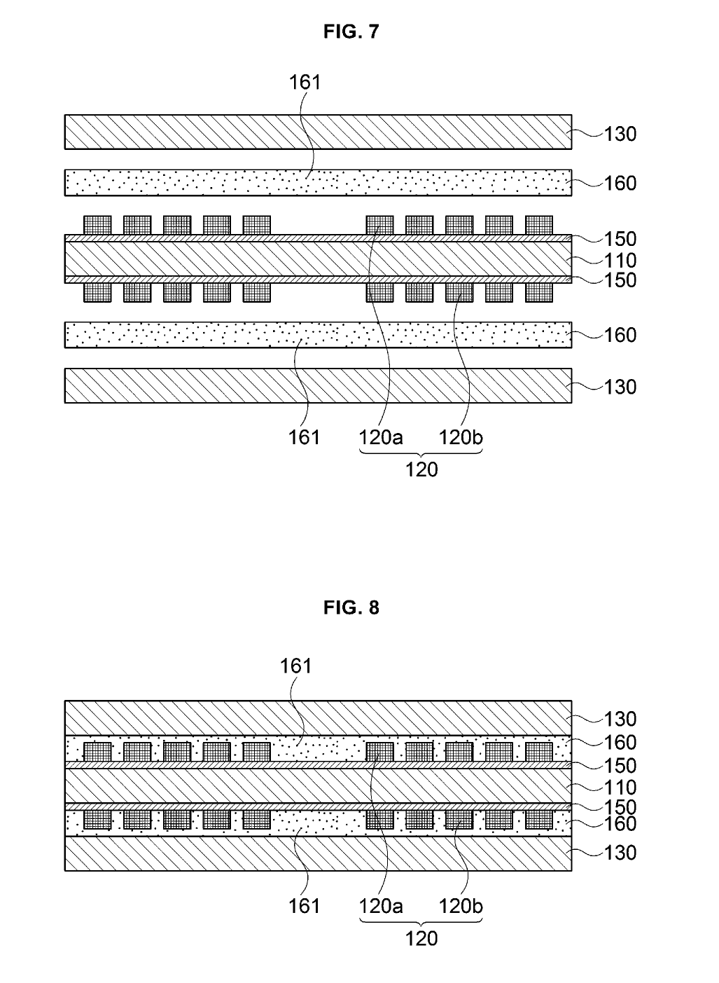

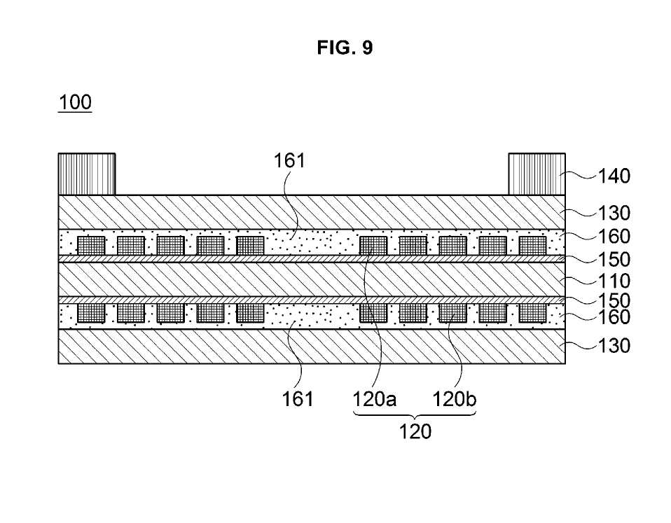

FIG. 3 is a diagram illustrating an example of a method of manufacturing a coil component. The operations in FIG. 3 may be performed in the sequence and manner as shown, although the order of some operations may be changed or some of the operations omitted without departing from the spirit and scope of the illustrative examples described. Many of the operations shown in FIG. 3 may be performed in parallel or concurrently. The above description of FIGS. 1-2, is also applicable to FIG. 3, and is incorporated herein by reference. Thus, the above description may not be repeated here. FIG. 4, FIG. 5, FIG. 6, FIG. 7, FIG. 8 and FIG. 9 illustrate steps of the method of manufacturing a coil component shown in FIG. 3.

In S100, a core magnetic layer 110 is prepared as shown in FIG. 4, In S110, as shown in FIG. 5, insulation layers 150 are coated on either surface of the core magnetic layer 110.

The core magnetic layer 110 may be manufactured in a bulk type by use of magnetic powder made of a Ni-based ferrite material, a Ni—Zn ferrite material or a Ni—Zn—Cu ferrite material. In another example, the core magnetic layer 110 may be manufactured by sintering a plurality of laminated ferrite sheets made of the Ni-based ferrite material, the Ni—Zn ferrite material or the Ni—Zn—Cu ferrite material.

The insulation layers 150 may be formed by applying a general spin coating process to the core magnetic layer 110 formed as described above. Here, the thickness of the insulation layers 150 is controlled by adjusting the thickness of coating, and the insulation layers 150 are formed with a thickness that is sufficient to alleviate a surface roughness of the core magnetic layer 110.

In S120, as shown in FIG. 6, the coil conductors 120 are formed on the insulation layers 150.

The coil conductors 120 may be formed using a plating process known to those skilled in the art, for example, a semi-additive process (SAP), a modified semi-additive process (MSAP) or a subtractive process.

Here, as illustrated, a first coil conductor 120a may be formed above the core magnetic layer 110, and a second coil conductor 120b may be formed below the core magnetic layer 110. In another example, the first coil conductor 120a and the second coil conductor 120b may be alternately disposed on a same plane.

When the coil conductors 120 are each formed in multiple layers, the coil conductors 120 may be insulated from one another by the insulation layers 150 by performing plating processes and spin coating processes repeatedly.

In S130, outer magnetic layers 130 are disposed over the coil conductors 120 with a polymer resin layer 160 separating the magnetic layers 130 from the coil conductors 120.

Similar to the core magnetic layer 110, the outer magnetic layers 130 may be manufactured in a bulk type or may be manufactured by sintering a plurality of laminated ferrite sheets. The polymer resin layers 160 may be formed with a thickness that is sufficient to fully cover the coil conductors 120. As shown in FIG. 7, after disposing the polymer resin layers 160 between the core magnetic layer 110 and the outer magnetic layers 130, the outer magnetic layers 130 are compressed toward the core magnetic layer 110 under a predetermined condition. As shown in FIG. 8, this results in the coil conductors 120 being buried in the polymer resin layers 160 and the outer magnetic layers 130 being joined with the core magnetic layer 110 through the polymer resin layers 160 (FIG. 8).

Once the outer magnetic layers 130 are formed as described above, external terminals 140 are formed on the outer magnetic layers 130 through a plating process to complete a coil component 100, as shown in FIG. 9.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A coil component comprising:
a core magnetic layer;
coil conductors formed on two opposing surfaces of the core magnetic layer; and
outer magnetic layers laminated on the core magnetic layer and covering the coil conductors.

2. The coil component of claim 1, wherein the core magnetic layer and the outer magnetic layers are made of at least one of Ni-based ferrite, Ni—Zn ferrite, or Ni—Zn—Cu ferrite.

3. The coil component of claim 1, further comprising insulation layers disposed between the core magnetic layer and the coil conductors.

4. The coil component of claim 1, further comprising polymer resin layers interposed between the core magnetic layer and the outer magnetic layers, and the coil conductors being buried in the polymer resin layers.

5. The coil component of claim 4, wherein the polymer resin layers comprise magnetic powder.

6. The coil component of claim 1, wherein the coil conductors comprise a first coil conductor and a second coil conductor that are electromagnetically coupled with each other.

7. The coil component of claim 1, further comprising external terminals disposed on the outer magnetic layers and electrically connected with the coil conductors.

8. The coil component of claim 1, wherein the coil conductors comprise metal wiring that winds on a plane in a spiral form, and the metal wiring is made of any one or any combination of silver (Ag), palladium (Pd), aluminum (Al), nickel (Ni), titanium (Ti), gold (Au), copper (Cu), and platinum (Pt).

9. The coil component of claim 7, wherein the coil conductors are electrically connected with external terminals through vias.

10. The coil component of claim 4, wherein the polymer resin layers are configured to provide electrical insulation between turns in the coil conductors.

11. The coil component of claim 4, wherein the polymer resin layers is configured to be heat-resistant, moisture-resistant, and an insulator.

12. A method of manufacturing a coil component, comprising:
preparing a core magnetic layer;
forming coil conductors on two opposing surfaces of the core magnetic layer; and
laminating outer magnetic layers on the core magnetic layer to cover the coil conductors.

13. The method of claim 12, wherein the laminating of the outer magnetic layers comprise disposing polymer resin layers between the outer magnetic layers and the core magnetic layer, and compressing the outer magnetic layers towards the core magnetic layer.

14. The method of claim 12, further comprising coating insulation layers on the opposing surfaces of the core magnetic layer prior to the forming of the coil conductors.

15. The method of claim 12, further comprising forming external terminals on the outer magnetic layers.

16. The method of claim 13, wherein the outer magnetic layers are compressed towards the core magnetic layer under a predetermined condition.

17. The method of claim 14, wherein the coating of the insulation layers comprise applying a spin coating process to the core magnetic layers to form the insulation layers with thickness sufficient to cover a surface roughness of the core magnetic layer.
